(19) United States
(12) Patent Application Publication
(10) Pub. No.: US 2007/0022481 A1
(43) Pub. Date: Jan. 25, 2007

(54) Network support for restricting call terminations in a security risk area

(76) Inventors: Stuart Owen Goldman, Scottsdale, AZ (US); Richard E. Krock, Naperville, IL (US); Bernard Louis Malone III, Little Rock, AR (US); Francis Edward O'Brien, Lafayette, NJ (US); Karl F. Rauscher, Emmaus, PA (US); George E. Rittenhouse, Holmdel, NJ (US); James Philip Runyon, Wheaton, IL (US)

Correspondence Address: Lucent Technologies Inc.,;Docket Administrator - Room 3J-219, 101 Crawfords Corner Road, Holmdel, NJ, 07733-3030, US

(21) Appl. No.: 11/187,232

(22) Filed: Jul. 22, 2005

(51) Int. Cl. H04N 7/16

(52) U.S. Cl. 726/26

(57) ABSTRACT

A precautionary measure against cell-phone triggered bombs is described that restricts call terminations within a designated security risk area without shutting down the entire network. Embodiments described herein provide for restricting call terminations directed to a designated security risk area that are originated from non-privileged users, i.e., the general public, yet authorizing call terminations directed to the security risk area that are originated from privileged government users (e.g., GETS/WPS users). Call originations are permitted within the security risk area from both privileged and non-privileged users.

### FIELD OF THE INVENTION

This invention relates generally to the field of telecommunication systems and, more particularly, to a system and methods for restricting call terminations in certain security risk areas.

### BACKGROUND OF THE INVENTION

Communication systems are well known in which persons may receive incoming calls (using, for example, a wireless, phone or other subscriber device) from other persons or devices calling the called party phone. Typically, the called party phone includes a “ringer” for playing a ring sequence or melody so as to alert the called party of the incoming call. Sadly, it is a known tactic of terrorist organizations to trigger bombs with wireless phones such that the ringing of the phone will detonate the bomb. It is a concern that this tactic will continue to be used to trigger further terrorist attacks against the United States and its allies throughout the world. Accordingly, there is a need for precautionary measures to respond to this threat. Most particularly, the need for precautionary measures applies to designated security risk areas or sectors that are at a heightened risk of attack. On Jul. 7, 2005, for example, multiple bombings occurred in London on subways and metropolitan bus systems. These attacks created a heightened concern that further bombings may be imminent in London and throughout the world, and indeed, another bombing attempt did occur in the London mass transit system on Jul. 21, 2005. Responsive to the London bombings, the United States Department of Homeland Security raised the security level from Code Yellow, or Elevated, to Code Orange, High-targeted to the mass transit portion of the transportation sector, including regional and passenger rail, subways, and metropolitan bus systems throughout the United States.

Generally, government and police authorities desiring to protect against terrorist attacks must choose precautionary measures commensurate with the threat yet still try to allow citizens to go about their daily lives with minimal disruption. One approach—and the approach practiced in the London bombings—is to shut down the wireless phone networks for a period of time so as to preclude the possibility that follow-up bombs may be triggered with wireless phones. A problem with this practice, however, is that shutting down the network disables users from placing or receiving any calls and adds to the public's confusion. Moreover, shutting down the network also effectively disables certain privileged users of the network such as police, fire or emergency personnel and/or government users from placing and receiving emergency calls to deal with the threat or actual disaster situation. In the United States, a nationwide Wireless Priority Service (WPS) provides priority treatment for privileged users in wireless networks. A complementary system, known as Government Emergency Telecommunications Service (GETS), provides priority treatment for privileged users in selected landline networks.

### SUMMARY OF THE INVENTION

The present invention provides systems and methods for guarding against cell phone-triggered bombings while minimizing disruption to the general public as well as to government authorized callers. Embodiments of the invention provide for restricting call terminations directed to a designated security risk area that are originated from non-privileged users, i.e., the general public, yet authorizing call terminations in the security risk area originated from privileged government users. Call originations are permitted from both privileged and non-privileged users in the security area.

In one embodiment, upon receiving an incoming call directed to a called party, a serving mobile switching center (MSC) determines a location of the called party relative to a security risk area and determines whether the calling party is a privileged user (e.g., a WPS or GETS user). If the called party is within the security risk area and the calling party is not a privileged user, the MSC prevents the incoming call from being completed thereby precluding the call from triggering a bomb. The MSC completes the call if the calling party is a privileged user or if the called party is not within the security risk area.

In another embodiment, in response to a determination that an emergency situation is present or imminent within a critical area defining a security risk area, a network operations center sends a command to an MSC to restrict call terminations in the security risk area to non-privileged users but which command does not restrict call terminations from privileged users.

In yet another embodiment, there is provided a system comprising means for identifying one or more cells or cell sectors corresponding to a security risk area and sending a command to restrict call terminations in the security risk area; and a mobile switching center (MSC) operable responsive to the command to prevent call terminations in the security risk area originated from non-privileged users but allow call terminations originated from privileged users.

In still another embodiment, there is provided an article comprising one or more computer-readable signal-bearing media. The media includes means for preventing call terminations directed to a designated security risk area from non-privileged users and allow call terminations directed to the security risk area from privileged users.

### BRIEF DESCRIPTION OF THE DRAWINGS

The foregoing and other advantages of the invention will become apparent upon reading the following detailed description and upon reference to the drawings in which:

FIG. 1 is a block diagram of a communication system including mobile terminals located in a security risk area in which embodiments of the present invention may be implemented to restrict call terminations within the security risk area; and

FIG. 2 is a flowchart of a method exercised by a serving MSC to restrict call terminations within a designated security risk area.

### DESCRIPTION OF THE PREFERRED EMBODIMENT(S)

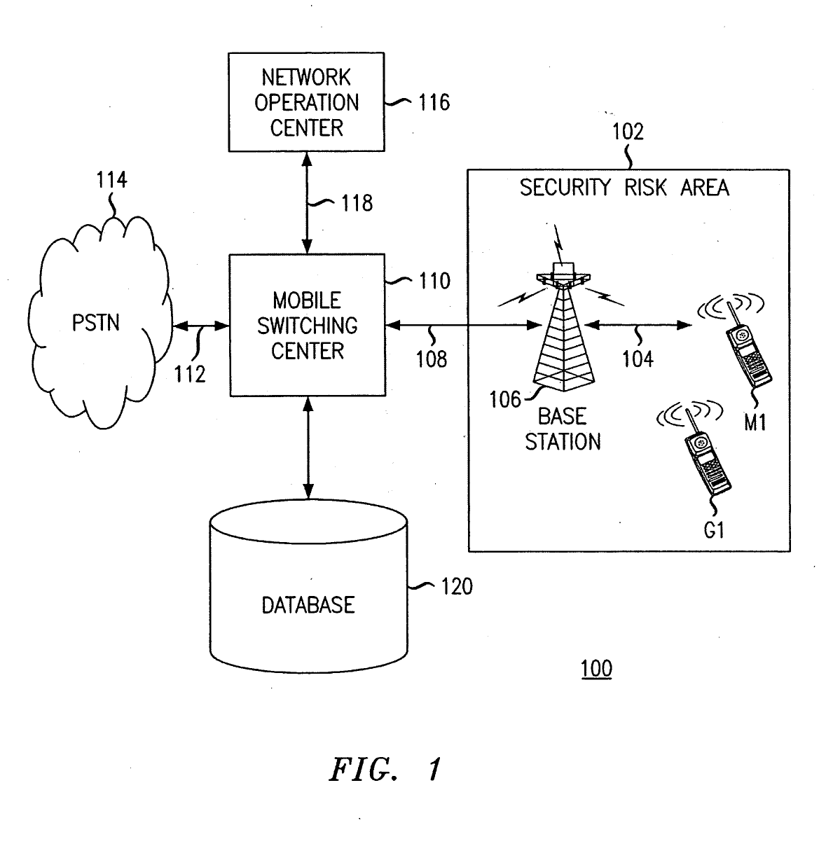

FIG. 1 shows a communication system 100 according to an exemplary embodiment of the invention that is operable to restrict termination of calls within a security risk area. A security risk area 102 defines a geographic area that is at a heightened risk of attack, as may be determined from actual events or intelligence reports and the like. The boundaries of the security risk area 102 may be defined corresponding to one or more cell sites or cell sectors (not shown). Typically, the security risk area 102 will include mobile terminals operated by non-privileged users (e.g., the general public) as well as mobile terminals operated by privileged users (e.g., government authorized users); the mobile terminals are also capable of receiving incoming calls from privileged or non-privileged users. As shown, mobile terminal M1 defines a terminal called by a non-privileged user and the mobile terminal G1 defines a terminal called by a government authorized user. As will be appreciated, the mobile terminals M1, G1 may comprise mobile phones or generally any type of subscriber device capable of receiving incoming calls, messages or the like.

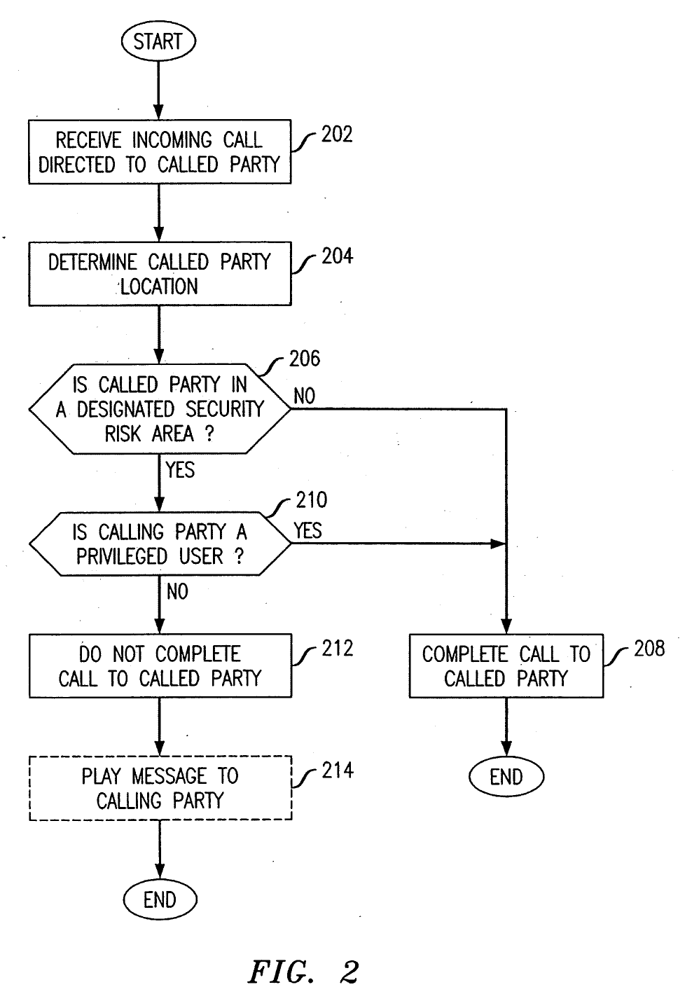

For purposes of illustration, it is presumed the mobile terminal M1 is a mobile phone rigged to detonate the bomb when it receives an incoming call, whereas the mobile terminal G1 is trusted as safe since the government authorized user has placed a call to that phone number and presumably knows that it is safe. As will be described in greater detail in relation to FIG. 2, embodiments of the present invention provide for restricting call terminations in the security risk area 102 originated by non-privileged users (e.g., directed to mobile terminal M1), yet authorizing call terminations from privileged government users (e.g., directed to mobile terminal G1). In such manner, the mobile terminal M1 is precluded from ringing and detonating a bomb, yet the trusted mobile terminal G1 is allowed to both originate and terminate calls.

The mobile terminals M1, G1 communicate via a wireless link 104 with one or more base stations 106 (one shown). The wireless link 104 may implement air interface technologies including but not limited to, CDMA, TDMA, GSM, UMTS or IEEE 802.11. The base station 106 is connected by link 108 to a switching element 110 (as shown, a mobile switching center (MSC)). The MSC 110 may comprise, for example, an AUTOPLEX™ switching system, available from Lucent Technologies, Inc. The MSC 110 includes a memory and processor (not shown), for storing and executing software routines for processing and switching calls and for providing various call features to calling or called parties, including the feature of restricting call terminations in the security risk area 102. The MSC 110 may be configured for operation with generally any suitable circuit, cell, or packet switching technology. As will be appreciated, the MSC 110 is a functional element that may reside in a single device or may be distributed among multiple devices and/or locations.

The MSC 110 is connected by link 112 to a network 114 (as shown, the Public Switched Telephone Network (PSTN)). Alternatively or additionally, the network 114 may comprise or may be interconnected with a number of different types of networks including local area networks (LANs), wide area networks (WANs), metropolitan area networks (MANs), the Internet, virtual private networks (VPNs) and/or corporate intranets. As will be appreciated, the MSC 110 may receive incoming calls from, or direct outgoing calls to, any of several types of communication devices connected to the network 114. The network 114 may be implemented using any appropriate transmission, switching and routing technologies, including but not limited to Internet Protocol (IP) and Asynchronous Transfer Mode (ATM) technologies.

When a responsible authority such as, for example, the local or state police, the FBI, or other governmental agency has reason to believe that a bomb is within security risk area 102 that possibly might be remotely detonated by calling mobile terminal M1, a representative from such authority informs a network operations center 116 associated with the communications system 100. The network operations center may comprise, for example, a regional command center operated by a service provider for the purpose of administering a cellular phone network. The network operations center 116 upon affirming the identity of the authority and legitimacy of the received information, determines one or more cells or cell sectors encompassing or overlapping the security risk area 102 and also the base station(s) and MSC(s) serving the cells or cell sectors. In the example of FIG. 1, the security risk area 102 is presumed to correspond to the coverage area of base station 106, which is served by MSC 110. As will be appreciated, the security risk area 102 in a real-world scenario may correspond to multiple base station coverage areas and/or multiple serving MSCs. The act of determining which MSCs and associated base stations are associated with a designated security risk area can be accomplished by the network operation center 116.

Having identified the serving MSC (e.g., MSC 110) and base stations (e.g., base station 106) associated with the security risk area 102, the network operations center 116 sends a network management command to the serving MSC via link 118 to restrict call terminations in the cell(s) and cell sectors corresponding to the security risk area 102. Link 118 is a logical link that may be physically realized, without limitation, by conventional subscriber lines, Asynchronous Transfer Mode (ATM) lines, ISDN lines, Ethernet LAN or WAN, wireless links, and the like. Thereafter, during such time as the instruction is in effect, the MSC operates to restrict call terminations in the security risk area. As noted, embodiments of the present invention provide for preventing call terminations from non-privileged users (e.g., directed to mobile terminal M1), yet authorizing call terminations from privileged government users (e.g., directed to mobile terminal G1) in the security risk area 102. In one embodiment, the MSC determines that the incoming call is from a privileged user (e.g., a WPS or GETS call) from signaling information in the call request. The signaling information may comprise, for example, a GETS NS/EP indication in an incoming SS7 message or the WPS priority level.

As will be appreciated, when the event has passed and the threat of imminent bombings has sufficiently diminished, and the network operations center 116 is so informed by a responsible authority, the network operations center 116 may send a new network management command to the MSC 110 specifying that the affected area is no longer a security risk area and call terminations may resume. The security area may also be expanded, reduced, or moved as needed.

FIG. 2 is a flowchart of a method exercised by the serving MSC 110 to restrict call terminations within the designated security risk area 102. In one embodiment, the steps of FIG. 2 are implemented, where applicable, by software routines executed within the serving MSC 110. Generally, however, the steps of FIG. 2 may be implemented on any computer-readable signal-bearing media residing within or remote from the MSC. The computer-readable signal-bearing media may comprise, for example and without limitation, floppy disks, magnetic tapes, CD-ROMs, DVD-ROMs, hard disk drives or electronic memory. The computer-readable signal-bearing media store software, firmware and/or assembly language for performing one or more functions relating to the steps of FIG. 2.

At step 202, the MSC 110 receives an incoming call directed to a called party. The incoming call may comprise, without limitation, a voice, video and/or data call, electronic mail, page or SMS message. The source of the incoming call may comprise, without limitation, a wireline or wireless telephone, fax machine, personal digital assistant (PDA), computer and the like; and the called party may comprise, without limitation, a cellular radio/telephone, laptop computer, two-way radio, PDA and the like.

At step 204, the MSC 110 determines the called party location, for example, by consulting a database such as a home location register (HLR)/visited location register (VLR). Optionally, the MSC might also page the called party to determine its location, as is known in the art. However, in the case that call restriction is active in the security area, there is a risk that active paging could trigger a bomb. Thus, paging should not occur unless the call is originated from a privileged user.

At step 206, the MSC 110 determines whether the called party location corresponds to a cell within the designated security risk area 102. The MSC makes a decision on how to process the incoming call based on whether or not the called party is within the security risk area 102. If the called party is not within the security risk area, the MSC at step 208 completes the call to the called party as normal.

If the called party is in the security risk area 102, the MSC at step 210 determines whether the calling party is a privileged user. For example, the calling party may comprise a GETS or WPS user. If the calling party is a privileged user, the MSC at step 208 completes the call to the called party even though the called party is in the security risk area. However, if the calling party is not a privileged user, the MSC at step 212 prevents the call from being completed so as to preclude the possibility that the call will be used to detonate a bomb.

Optionally, at step 214, if the call is not completed because the call is directed to the security risk area and the calling party is not a privileged user, the MSC may play an announcement to the caller stating that calls cannot be completed at this time. Alternatively, rather than playing an announcement, the MSC may cause the incoming call to be redirected to voice mail of the called party. However, such an operation is normally followed by a message to the called party indicating that a message is waiting. There is a risk that such a message waiting indication could trigger a bomb. Accordingly, in one embodiment, the MSC suppresses the message waiting indication for so long as the called party is within the security risk area.

It is noted, while embodiments of the present invention operate to restrict call terminations directed to a designated security risk area that are originated by non-privileged users, the invention contemplates permitting call originations from non-privileged users (as well as privileged users) within the security risk area. In such manner, the threat of triggering a bomb is minimized with minimal disruption to the general population. Citizens will still be able to use their mobile terminals to call wireline destinations such as 9-1-1 or their homes or they may call other mobile terminals located outside of the affected area. As a further benefit, since the system is not shut down, the mobile terminals of any victims would still be operational for emergency calls or for location purposes.

The present invention may be embodied in other specific forms without departing from its spirit or essential characteristics. The described embodiments are to be considered in all respects only as illustrative and not restrictive. For example, although bombs have typically been detonated through a ringing mobile telephone, any other type of device such as a PDA, or other analog or digital mobile terminal or wireline terminal could be used to trigger any type of explosive device or weapon that could cause panic and/or harm to lives and property. Further, although described in connection with a bomb threat, embodiments of the present invention could be applied to other emergency situations that might occur in which a ringing mobile terminal or other device could deleteriously impact the situation either through triggering of another device, or from the ringing of the mobile terminal itself, as for example, in a hostage situation. The scope of the invention is, therefore, indicated by the appended claims rather than by the foregoing description. All changes that come within the meaning and range of equivalency of the claims are to be embraced within their scope.

What is claimed is:

1. A method comprising:
receiving an incoming call directed to a called party;
determining a location of the called party relative to a security risk area;
determining whether the calling party is a privileged user; and
preventing termination of the call if the called party is within the security risk area and the calling party is not a privileged user.

2. The method of claim 1, further comprising a step of completing the call if the calling party is a privileged user.

3. The method of claim 1, further comprising a step of completing the call if the called party is not within the security risk area.

4. The method of claim 1, wherein the step of determining a location comprises:
receiving indication of a security risk area;
determining one or more base station coverage areas corresponding to the security risk area; and
determining a location of the called party relative to the one or more base station coverage areas.

5. The method of claim 4, wherein the step of receiving indication of a security risk area comprises receiving indication of one or more cells of a wireless communication system.

6. The method of claim 4, wherein the step of receiving indication of a security risk area comprises receiving indication of one or more cell sectors of a wireless communication system.

7. The method of claim 1, wherein the step of determining whether the calling party is a privileged user comprises determining whether the calling party is a WVPS or GETS user.

8. A method comprising the steps of:
in response to a determination that an emergency situation is present or imminent within a critical area defining a security risk area, sending a command to restrict call terminations directed to the security risk area from non-privileged users but which command does not restrict call terminations from privileged users.

9. A system comprising:
means for identifying one or more cells or cell sectors corresponding to a security risk area and sending a command to restrict call terminations in the security risk area; and
a mobile switching center (MSC) operable responsive to the command to prevent call terminations directed to the security risk area from non-privileged users and allow call terminations directed to security risk area from privileged users.

10. An article comprising:
one or more computer-readable signal-bearing media; and
means in the one or more media for preventing call terminations directed to a designated security risk area from non-privileged users and allow call terminations directed to the security risk area from privileged users.

11. The article of claim 10, wherein the means in the one or more media for preventing call terminations includes:
means for determining that an incoming call originated from a calling party is directed to a called party within the security risk area;
means for determining whether the calling party is a privileged user; and
means for preventing termination of the call if the called party is within the security risk area and the calling party is not a privileged user.

12. The article of claim 11, further including means for completing the call if the calling party is a privileged user.
